(19) United States
(12) Patent Application Publication
(10) Pub. No.: US 2020/0081403 A1
(43) Pub. Date: Mar. 12, 2020

(54) PERSONALIZED WATCH

(71) Applicant: Victor Clay, Stockbridge, GA (US)

(72) Inventor: Victor Clay, Stockbridge, GA (US)

(21) Appl. No.: 15/943,695

(22) Filed: Apr. 2, 2018

Related U.S. Application Data
(60) Provisional application No. 62/480,355, filed on Apr. 1, 2017.

(51) Int. Cl. G04B 45/00; G04B 19/10; A44C 5/00

(52) U.S. Cl. CPC G04B 45/0092; A44C 5/0084; G04B 19/10

(57) ABSTRACT

Implementations of a personalized watch are provided. In some implementations, the personalized watch comprises a band having a plurality of removable ornamental links.

### CROSS REFERENCE TO RELATED APPLICATION

This application claims the benefit of U.S. Patent Application Ser. No. 62/480,355, which was filed on Apr. 1, 2017, and is incorporated herein by reference in its entirety.

### TECHNICAL FIELD

This disclosure relates to implementations of a personalized watch.

### BACKGROUND

Many people regularly wear a wrist-watch. The appearance of such watch is usually limited to a pre-determined mass-produced appearance that is not personalized to such people who wear the watch. Furthermore, an option, if any, to change the appearance of such watch is usually limited to a pre-determined mass-produced option that is not personalized to such people who wear the watch.

### BRIEF DESCRIPTION OF THE DRAWINGS

FIG. 1 illustrates an implementation of an example personalized watch according to the present disclosure.

FIG. 2 illustrates another implementation of an example personalized watch according to the present disclosure.

FIG. 3 illustrates another implementation of an example personalized watch according to the present disclosure.

### DETAILED DESCRIPTION

Implementations of a personalized watch are provided. In some implementations, the personalized watch comprises a band having a plurality of removable ornamental links.

In some implementations, the personalized watch includes a watch and a band with personalized links that include personalized appearances such as personally chosen or inspired images or engravings. In some implementations, the personalized watch also includes a watch with an interchangeable personalized face that includes personalized appearances such as personally chosen or inspired images or engravings. In some implementations, the personalized watch is configured to provide a wrist-watch with an appearance that is personalized to the wearer of the watch.

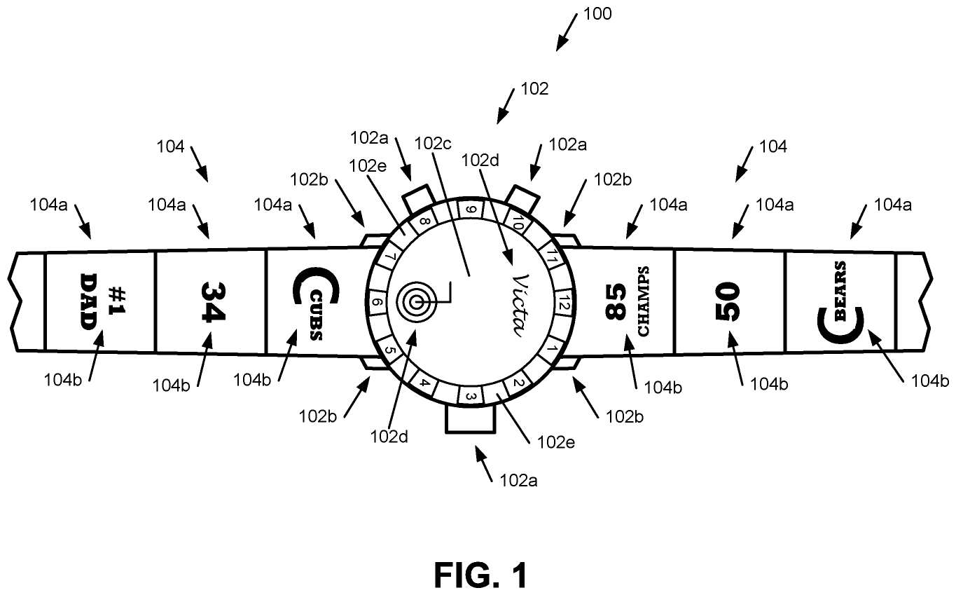

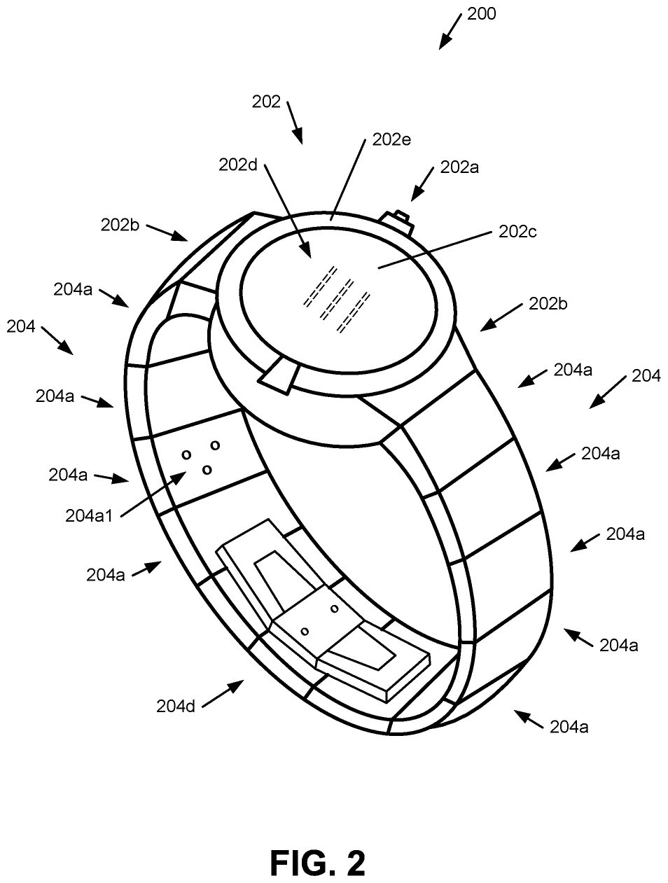

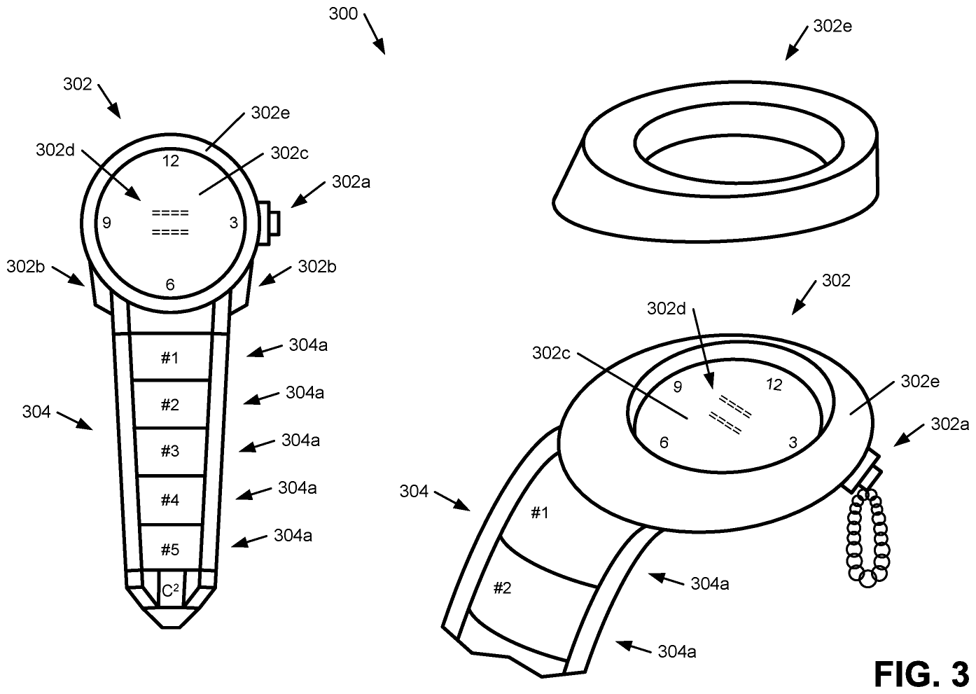

FIG. 1 illustrates an implementation of an example personalized watch 100 according to the present disclosure. In some implementations, the personalized watch 100 includes a watch 102 and a band 104 with personalized links 104a. FIGS. 2 and 3 illustrate other implementations of an example personalized watch 200, 300 according to the present disclosure. In some implementations, the personalized watch 200, 300 includes the same or similar structure and functions as the personalized watch 100 of FIG. 1.

In some implementations, the watch 102 may include any type of mechanical operation mechanism or movement. In some implementations, the watch 102 may include any type of electronic operation mechanism or movement. In some implementations, the watch 102 may include any other type of operation mechanism or movement.

In some implementations, the watch 102 may include any type of analog display. In some implementations, the watch 102 may include any type of digital display. In some implementations, the watch 102 may include any other type of display.

In some implementations, the watch 102 may include controls 102a. In some implementations, the controls 102a may be any type of controls for the functioning or setting of the watch 102.

In some implementations, the band 104 is attached to the watch 102 in a configuration for the personalized watch 100 to be worn as a wrist-watch. In some implementations, the band 104 is attached to the watch 102 at attachment points 102b. In some implementations, the attachment points 102b are lugs.

In some implementations, the band 104 is continuous between the attachments to the watch 102. In some implementations, the band 104 can separate into two segments between the attachments to the watch 102. In some implementations, as shown in FIG. 2, the band includes a clasp 204d or other type of connector.

In some implementations, the personalized links 104a are connected together to form the band 104. In some implementations, as shown in FIG. 2, the personalized links 204a may be connected by one or more screws 204a1. In some implementations, the personalized links 104a may be snapped onto the band. In some implementations, the personalized links 104a may be connected to the band or each other in any other suitable manner. In some implementations, one or more of the personalized links 104a is interchangeable with one or more other personalized links 104a that is or is not part of the band 104. In some implementations, as shown in FIG. 2, the band 204 comprises five (5) personalized links 204a on either side of the clasp 204d.

In some implementations, the personalized links 104a include various personalized appearances 104b such as personally chosen or inspired images or engravings. In some implementations, the personalized appearances 104b are related to personal or familial relationships, sports preferences or achievements, or club memberships (e.g., fraternities, etc.) or involvements. In some implementations, the personalized appearances 104b are related to any other suitable subject.

In some implementations, the personalized watch 100 also includes the watch 102 with an interchangeable personalized dial or face 102c. In some implementations, the personalized dial or face 102c includes all or part of the visible display of the watch. In some implementations, the personalized dial or face 102c includes one or more personally chosen or inspired colors and designs. For example, the outer perimeter of the personalized dial or face 102c may include one or more personally chosen or inspired colors and designs. In some implementations, the outer perimeter 102e of the personalized dial or face 102c may be interchangeable separately from the personalized dial or face 102c. In some implementations, the outer perimeter 102e includes part of the personalized dial or face 102c or the portion surrounding the personalized dial or face 102c, such as a face plate 202e as shown in FIG. 2 or a bezel 302 as shown in FIG. 3.

In some implementations, the personalized face 102c includes one or more personalized appearances 102d such as personally chosen or inspired images or engravings displayed by the personalized face 102c.

In some implementations, the personalized appearances 102d are related to personal or familial relationships, sports preferences or achievements, or club memberships or involvements. In some implementations, the personalized appearances 102d are related to any other suitable subject.

In some implementations, the personalized appearances 102d of the personalized face 102c may be the same or similar to the personalized appearances 104b of the personalized links 104a. In some implementations, the personalized appearances 102d of the personalized face 102c may be different from the personalized appearances 104b of the personalized links 104a.

In some implementations, the personalized watch 100 or components of the personalized watch 100 such as the watch 102, personalized face 102c, band 104, and personalized links 104a may be composed of any suitable material such as metal, plastic, etc. In some implementations, the personalized watch 100 or components of the personalized watch 100 such as the watch 102, personalized face 102c, band 104, and personalized links 104a may have various colors or other appearances.

Any existing or future developed method or mechanism for attaching and removing the personalized links 104a or personalized dial or face 102c or outer perimeter thereof may be used in the present disclosure. One of ordinary skill in the art would know with benefit of this disclosure how to attach or remove the personalized links 104a or personalized dial or face 102c or outer perimeter thereof.

The figures, including photographs and drawings, included herewith may represent one or more implementations of the personalized watch.

Reference throughout this specification to “an embodiment” or “implementation” or words of similar import means that a particular described feature, structure, or characteristic is included in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A watch comprising:
a band having a plurality of removable ornamental links, wherein at least two of the ornamental links are chosen from a group of the ornamental links comprising a plurality of the ornamental links that are different and intended to convey different messages or different visual appearances, and wherein the at least two ornamental links are different and convey different messages or different visual appearances, and wherein the at least two ornamental links are arranged on the band in a distinctive arrangement; and
a removable dial, wherein the dial is chosen from a group of dials comprising a plurality of the dials that are intended to convey a different visual appearances.

2. The watch of claim 1 wherein the group of dials comprises a plurality of the dials having different colors.

3. The watch of claim 1 wherein the group of the ornamental links comprise at least one of the ornamental links having a first indicia, at least one of the ornamental links having a second indicia, and at least one at least one of the ornamental links having a third indicia, wherein the first, second, and third indicia are different.

4. The watch of claim 3 wherein one of the indicia is a sports indicia and an other one of the indicia is a membership indicia.

5. The watch of claim 3 wherein one of the indicia is a fraternity indicia.

6. The watch of claim 3 wherein one of the indicia is a month indica.

7. A method of personalizing the watch of claim 1 having the plurality of removable ornamental links and the removable dial, the method comprising:
selecting the at least two different ornamental links from the group of ornamental links comprising the plurality of different ornamental links intended to convey different messages or different visual appearances;
arranging the at least two different ornamental links on the band in the distinctive arrangement;
selecting the dial from the group of dials; and
attaching the dial on the watch.

8. A watch comprising:
a band having a plurality of removable ornamental links wherein at least two of the ornamental links are chosen from a group of the ornamental links comprising a plurality of the ornamental links that are different and intended to convey different messages or different visual appearances, and wherein the at least two ornamental links are different and convey different messages or different visual appearances, and wherein the at least two ornamental links are arranged on the band in a distinctive arrangement; and
a removable dial, wherein the dial is chosen from a group of dials comprising a plurality of the dials that are intended to convey a different visual appearances,
wherein the group of the ornamental links comprise at least one of the ornamental links having a first indicia, at least one of the ornamental links having a second indicia, and at least one at least one of the ornamental links having a third indicia, wherein the first, second, and third indicia are different, and wherein one of the indicia is a sports indicia, a first other one of the indicia is a membership indicia, and a second other one of the indicia is a month indicia.

9. A watch comprising a band having a plurality of removable ornamental links wherein at least two of the ornamental links are chosen from a group of the ornamental links comprising a plurality of the ornamental links that are different and intended to convey different messages or different visual appearances, and wherein the at least two ornamental links are different and convey different messages or different visual appearances, and wherein the at least two ornamental links are arranged on the band in a distinctive arrangement.
